(19) United States
(12) Patent Application Publication
(10) Pub. No.: US 2021/0122559 A1
(43) Pub. Date: Apr. 29, 2021

(54) DRIFTER BOX

(71) Applicant: Donald Leonard O'Dell, Chemainus (CA)

(72) Inventor: Donald Leonard O'Dell, Chemainus (CA)

(21) Appl. No.: 16/663,963

(22) Filed: Oct. 25, 2019

(51) Int. Cl. B65D 85/14

(52) U.S. Cl. CPC B65D 85/14; A47G 21/189

(57) ABSTRACT

A case comprising a holder for a reusable, collapsible straw.

### BACKGROUND

While environmental impacts of disposable plastics on oceans, beaches and landfills has become a prominent, global issue, challenges remain in pursuit of a timely, effective solution. Solutions that will help resolve these plastic issues are already being sought out. Food industry giants are actively phasing out the use of plastic straws for disposable, paper straws. Even large cities, such as Seattle in the United States, have outright banned the use of any non-recyclable or non-compostable packaging, such as plastic straws. While businesses and governments gradually unite to eliminate the use and production plastic straws, there exists a need to provide a solution directly to the consumer.

When considering the environmental impacts of paper straws, it's important to recognize the energy required in their production and the source of this energy. Unless the energy used in the paper straw production is solely derived from renewable energy resources, the production of paper straws can contribute to adverse environmental effects, such as the addition of greenhouse gases emitted into the atmosphere. Furthermore, paper products are generally more energy intensive to produce compared to plastic products, as a consequence, a greater amount of energy resources are required in the production of paper straws. Since paper straws are intended to be used in the same manner as plastic straws, that is, as a single-use product, there exists a need to provide reusable straws.

Currently, reusable straws exist within the market that are constructed from an array of materials, such as plastic, silicon and stainless steel. These reusable straws are typically telescopic for compactness and for ease of transportation but lack a convenient vehicle for timely use. There exists a need for a convenient way to carry and access a reusable straw such that is conveniently accessible when needed.

### BRIEF SUMMARY

The present embodiment encompasses a portable, protective case comprising a holder for a reusable, collapsible straw. In further embodiments, the reusable, collapsible straw is substantially made of stainless steel. In other embodiments, the reusable, collapsible straw is substantially made of plastic. In other embodiments, the reusable, collapsible straw is substantially made of silicon. In other embodiments, the holder is secured using a clip that is attached to the case. In other embodiments, the clip is attached at the back. In other embodiments, the reusable, collapsible straw is secured using a clip that is attached to the case. In other embodiments, the clip is attached at the back. In other embodiments, the holder is built into the case. In other embodiments, the reusable, collapsible straw is built into the case. In other embodiments, the holder has a lid. In other embodiments, the case is a cellphone case. In other embodiments, the case is a tablet case. In other embodiments, the holder is comprised of an array of colors. In other embodiments, the straw is comprised of an array of colors. In other embodiments, the holder has a name or design etched onto it. In other embodiments, the straw has a name or design etched onto it.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a side profile of a reusable, collapsible straw attached to the back of the case 100 in accordance with one embodiment.

FIG. 2 illustrates a back profile of a reusable, collapsible straw attached to the side of the case 200 in accordance with one embodiment.

FIG. 3 illustrates a side profile of a reusable, collapsible straw affixed to the back of the case 300 in accordance with one embodiment.

FIG. 4 illustrates a back profile of a reusable, collapsible straw affixed to the side of the case 400 in accordance with one embodiment.

FIG. 5 illustrates a front profile of a reusable, collapsible straw affixed to the side of the case 500 in accordance with one embodiment.

FIG. 6 illustrates a side profile of a straw holder attached to the back of the case 600 in accordance with one embodiment.

FIG. 7 illustrates a back profile of a straw holder attached to the side of the case 700 in accordance with one embodiment.

FIG. 8 illustrates a side profile of a reusable, collapsible straw with lid affixed to the back of the case 800 in accordance with one embodiment.

FIG. 9 illustrates a back profile of a reusable, collapsible straw with lid affixed to the side of the case 900 in accordance with one embodiment.

### DETAILED DESCRIPTION

The details of one or more embodiments of the subject matter of this specification are set forth in the accompanying drawings and the description below. Other features, aspects, and advantages of the subject matter will become apparent from the description, the drawings, and the claims.

Like reference numbers and designations in the various drawings indicate like elements.

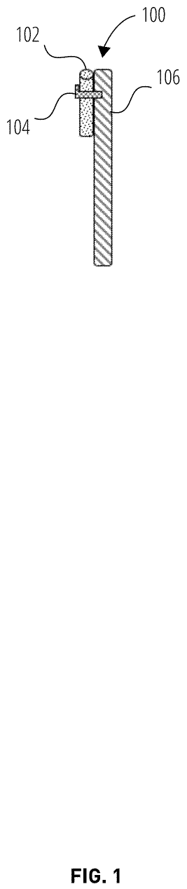

FIG. 1 provides an overview of a side profile of a reusable, collapsible straw attached to the back of the case 100 as used in one embodiment. This example displays a collapsible straw 102 in its collapsed state, attached to the back face of the case 106 by means of an attachable clip 104.

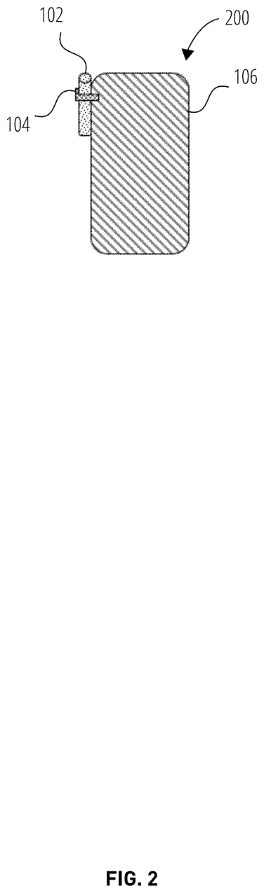

FIG. 2 provides an overview of a back profile of a reusable, collapsible straw attached to the side of the case 200 as used in one embodiment. This example displays a reusable, collapsible straw 102 in its collapsed state, attached to the side of the case 106 by means of an attachable clip 104.

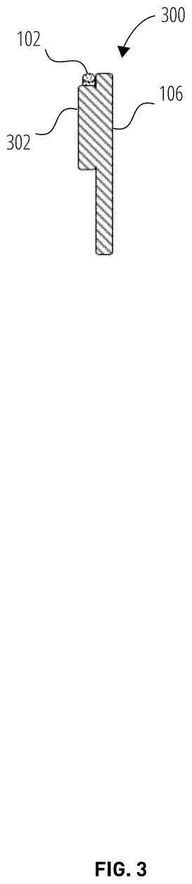

FIG. 3 provides an overview of a side profile of a reusable, collapsible straw affixed to the back of the case 300 as used in one embodiment. This example displays a reusable, collapsible straw 102 in its collapsed state, affixed to the back face of the case 106 by means of a built-in holder 302.

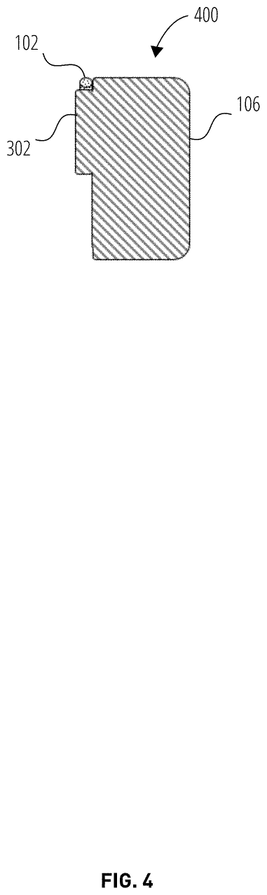

FIG. 4 provides an overview of a back profile of a reusable, collapsible straw affixed to the side of the case 400 as used in one embodiment. This example displays a reusable, collapsible straw 102 in its collapsed state, affixed to the side of the case 106 by means of a built-in holder 302.

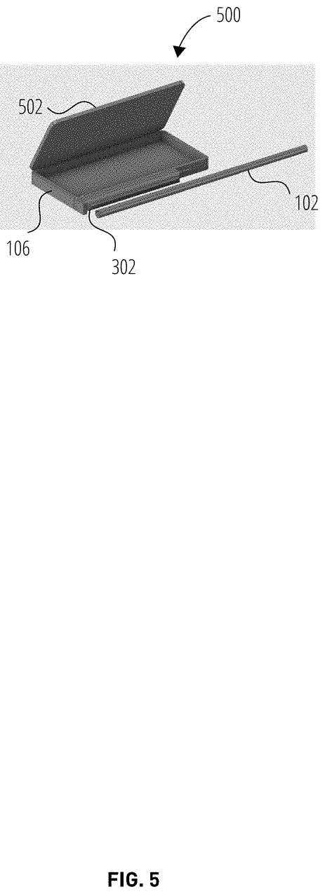

FIG. 5 provides an overview of a front profile of a reusable, collapsible straw affixed to the side of the case 500 as used in one embodiment. This example displays a reusable, collapsible straw 102 in its expanded state, positioned next to the built-in holder 302. The built-in holder 302 is located on the side of the case 106, which is equipped with a case cover 502.

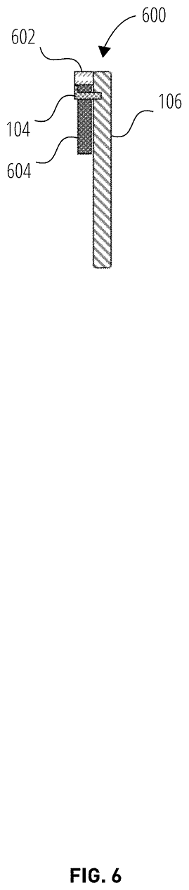

FIG. 6 provides an overview of a side profile of a straw holder attached to the back of the case 600 as used in one embodiment. This example displays a straw holder comprised the straw holder lid 602 and the straw holder body 604, where the reusable, collapsible straw 102 is encased while in its collapsed state. The straw holder is attached to the back face of the case 106 by means of an attachable clip 104.

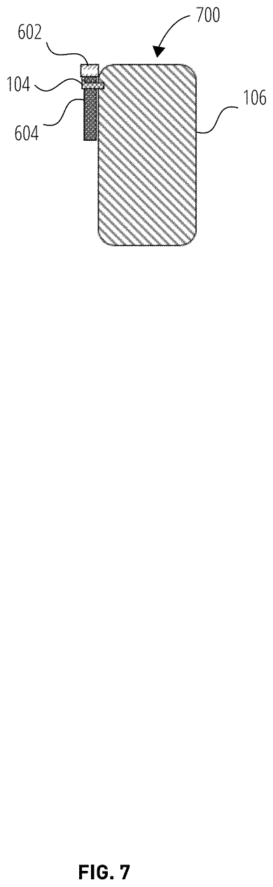

FIG. 7 provides an overview of a back profile of a straw holder attached to the side of the case 700 as used in one embodiment. This example displays a straw holder comprised the straw holder lid 602 and the straw holder body 604, where the reusable, collapsible straw is encased while in its collapsed state. The straw holder is attached to the side of the case 106 by means of an attachable clip 104.

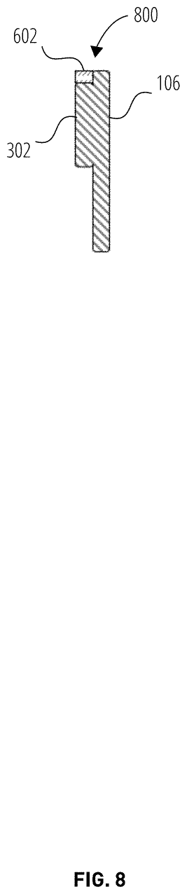

FIG. 8 provides an overview of a side profile of a reusable, collapsible straw with lid affixed to the back of the case 800 as used in one embodiment. This example displays a straw holder comprised the straw holder lid 602, where the reusable, collapsible straw is encased within a built-in holder 302 at the back face of the case 106.

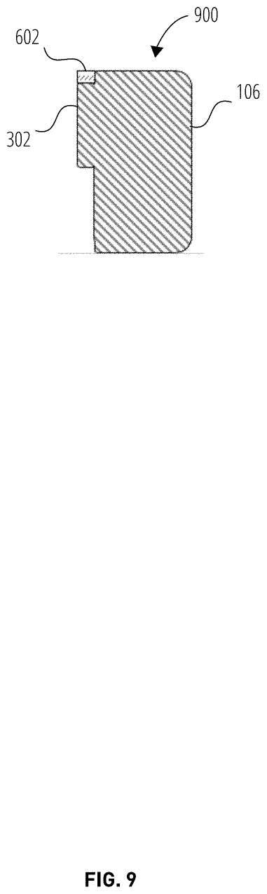

FIG. 9 provides an overview of a back profile of a reusable, collapsible straw with lid affixed to the side of the case 900 as used in one embodiment. This example displays a straw holder comprised the straw holder lid 602, where the reusable, collapsible straw is encased within a built-in holder 302 at the side of the case 106.

What is claimed is:

1. A portable, protective case comprising a holder for a reusable, collapsible straw.

2. The case of claim 1 wherein the reusable, collapsible straw is substantially made of stainless steel.

3. The case of claim 1 wherein the reusable, collapsible straw is substantially made of plastic.

4. The case of claim 1 wherein the reusable, collapsible straw is substantially made of silicon.

5. The case of claim 1 wherein the holder is secured using a clip that is attached to the side of the case.

6. The case of claim 5 wherein the clip is attached at the back of the case.

7. The case of claim 1 wherein the reusable, collapsible straw is secured using a clip that is attached to the side of the case.

8. The case of claim 7 wherein the clip is attached at the back of the case.

9. The case of claim 1 wherein the holder is built into the case.

10. The case of claim 1 wherein the reusable, collapsible straw is built into the case.

11. The case of claim 1 wherein the holder has a lid.

12. The case of claim 1 wherein the case is a cellphone case.

13. The case of claim 1 wherein the case is a tablet case.

14. The case of claim 1 wherein the holder is comprised of an array of colors.

15. The case of claim 1 wherein the straw is comprised of an array of colors.

16. The case of claim 1 wherein the holder has a name or design etched onto it.

17. The case of claim 1 wherein the straw has a name or design etched onto it.
